(19) United States
(12) Patent Application Publication
(10) Pub. No.: US 2002/0062271 A1
(43) Pub. Date: May 23, 2002

(54) Method and system for managing portfolio accounts

(76) Inventor: Peter Breuninger, Wayne, PA (US)

Correspondence Address: SAUL EWING LLP, CENTRE SQUARE WEST, 1500 MARKET STREET, 38TH FLOOR, PHILADELPHIA, PA, 19102-2186, US

(21) Appl. No.: 09/978,163

(22) Filed: Oct. 15, 2001

Related U.S. Application Data
(60) Provisional application No. 60/240,486, filed on Oct. 13, 2000.

(51) Int. Cl. G06F 17/60

(52) U.S. Cl. 705/36

(57) ABSTRACT

The present invention is a method and system for managing portfolio products that is low cost, easy to use and ideal for smaller accounts. The present invention is a turn-key, private label money management system, acting as an electronic interface between an individual or a small financial institution and an individual investment account. The present invention bundles custody, portfolio management and statement reporting in a seamless “private label” system, allowing small financial institutions to provide to their clients with investment management services. The present invention automates account management and custody with one custodial partner over an Internet delivery system, allowing individuals and financial institutions investment management services at costs considerably lower than those available through individually managed portfolios. The present invention also provides individual investor risk assessment, including advice directed to portfolios meeting certain investment needs. Furthermore, the invention provides access to investment related educational software.

### RELATED APPLICATIONS

The present application claims priority from pending provisional application No. 60/240,486, filed Oct. 13, 2000, entitled “System for Managed Portfolio Accounts.”

### FIELD OF THE INVENTION

The present invention relates generally to money management systems, and more particularly to a portfolio management outsourcing method and system for financial institutions.

### BACKGROUND OF THE INVENTION

The cost of providing money management services to investors is the same whether an account is valued at $25,000 or $1,000,000. However, a $1,000,000 account typically produces about 40 times greater revenues than the $25,000 account. Because of this discrepancy in generated revenue, small investors are often denied money management services, as investment firms target and accept only clients having substantial assets to invest by requiring high minimums for management services.

In the United States, individuals with investment assets exceeding $1,000,000 represent only about 6% of all investors. In contrast, a great majority of investors have relatively modest finds for investment (i.e., $250,000 or less). As a result, approximately 90% of investors receive no professional investment advice or money management services.

In addition, the cost of providing money management services (in relation to return revenues generated therefrom) precludes small financial institutions from providing their customers with these services. Small financial institutions can include small to mid-sized banks, credit unions, investment advisors/brokers, insurance companies and pension plans tending to serve investors with modest resources.

For the foregoing reasons, there is a need for low cost investment management services for modest investors, providing services that educate, advise and manage accounts to modest investors either individually or through small financial institutions.

### SUMMARY OF THE INVENTION

The present invention is a method and system for managing portfolio products that is low cost, easy to use and ideal for smaller accounts. The present invention is a turn-key, private label money management system, acting as an electronic interface between an individual or a small financial institution and an individual investment account. The present invention bundles custody, portfolio management and statement mailing in a seamless “private label” system, allowing small financial institutions to provide to their clients with investment management services.

The present invention automates account management and custody with one custodial partner, allowing individuals and financial institutions investment management services at costs considerably lower than those available through individually managed portfolios. The present invention also provides individual investor risk assessment, including advice directed to portfolios meeting certain investment needs. Furthermore, the invention provides access to investment related educational software.

In one aspect of the invention, an investor can open an account through a financial institution. Various portfolios are provided for investment through the financial institution, each portfolio having a different investment distribution representing a specific characteristic of risk. Funds are accepted from the investor, through the financial institution, for placement into the account. The investor selects one or more of the portfolios through which to distribute invested finds, and securities are purchased. The present invention processes and maintains certificates, the certificates memorializing the securities purchased with the funds accepted from the investor. The present invention also monitors the performance of the portfolios and allows the investor to access the account through the financial institution, to modify the funds invested into one or more of the portfolios and to buy or sell securities.

In another aspect of the invention, the present invention also assesses investment risk characteristics of the investor. Assessing the investor's characteristic of risk could involve a financial questionnaire directed to identifying investment objectives, then providing investment strategies resulting therefrom.

In another aspect of the invention, the investment management services are transparent to the investor. The investor could access the account by computer, over the Internet, through the financial institution, where the web pages are branded with identifying material of the financial institution. The investor could also access the account by automatic teller machine, through the financial institution, where the displays of the automatic teller machine are branded with identifying material of the financial institution.

In another aspect of the invention, fees for the investment management services are based on total assets managed rather than on commission. Total assets managed could be quantified and paid by individual investor account. The financial institutions could receive a portion of the fee as incentive to provide the product delivery system of the present invention.

It is therefore one object of the present invention to provide marketing, risk evaluation, investment management, custody and statement mailing in an electronic system that simplifies investing for the end customer (investor) and the financial institution.

It is another object of the present invention to provide a low cost and understandable managed investment product designed to fit basic individual, family and smaller entity needs.

It is another object of the present invention to provide to product through traditional distribution channels (i.e., banks, brokerage firms, credit unions, investment advisors and insurance companies) and over the Internet.

It is another object of the present invention to deliver the product through a packaged turnkey system via Internet technology, thereby removing the back office interface from the investor.

### BRIEF DESCRIPTION OF THE DRAWINGS

For the purpose of illustrating the invention, there is shown in the drawing(s) a form which is presently preferred; it being understood, however, that this invention is not limited to the precise arrangements and instrumentalities shown.

FIG. 1 is a block diagram illustrating communication between an investor or small institution, a Techfi portfolio management system and a Datalynx® custodian, according to the present invention.

### DETAILED DESCRIPTION OF THE INVENTION

The present invention is a method and system for managing portfolio investments, providing a private label money management system for financial institutions. The present invention provides risk assessment for investors to aid the investor in investment decisions, and direct the investors to an appropriate managed portfolio. The invention accepts funds and provides automatic account assessments and reports at regular intervals. The invention allows users to make inquiries into investments and shift funds among managed portfolio accounts through an Internet turnkey device. In addition, the invention provides access to educational and advising information related to investing. All investments created through the system are stored electronically through a centralized custodian.

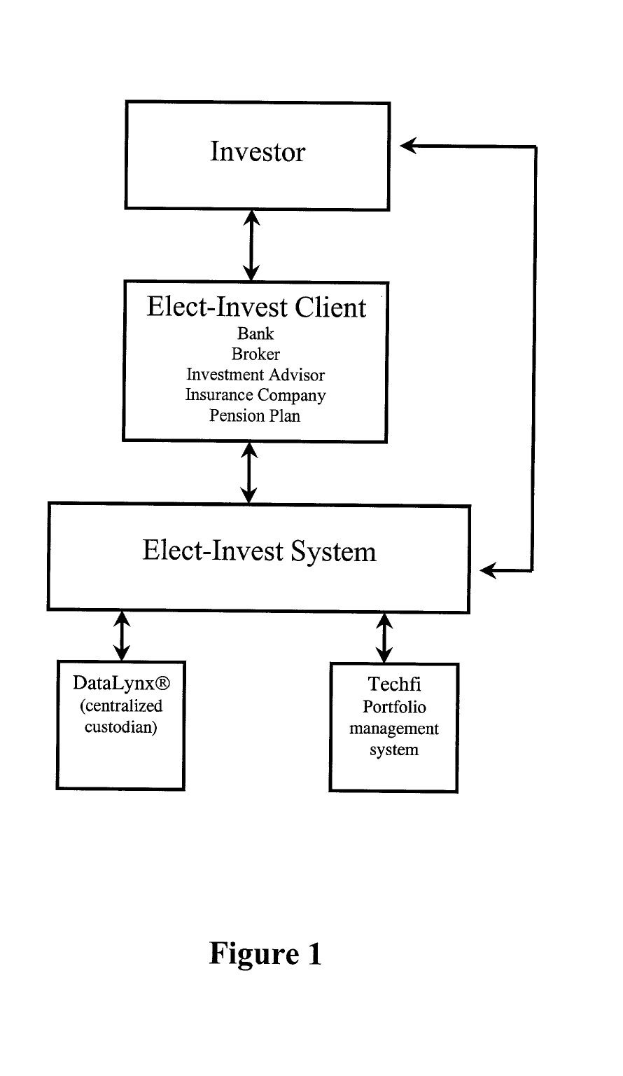

FIG. 1 is a block diagram illustrating one embodiment of communication between an investor or small institution, a Techfi portfolio management system (by Techfi Corp., Colorado), and a Datalynx® custodian (by First Trust Corp., Colorado). The Techfi portfolio management system facilitates the buying and selling of securities or mutual funds and continually assesses funds included in the managed investment portfolios to determine and ensure portfolio performance. Securities of funds included in the investment portfolios, represented by certificates, are held by a Datalynx® centralized custodian that provides centralized accounting (i.e., reconciliation of dividends, purchases and redemptions) and statement reporting (i.e., periodic statement e-mails and/or mailings). The Techfi and Datalynx® components allow the system of the present invention to offer financial institutions one-stop small account management. The present invention is not limited, however, to these proprietary components.

To initiate an account, investors are provided an optional risk assessment analysis, which might employ a programmed, six-step questionnaire. This analysis includes a series of questions designed to assess factors such as the individual's retirement needs, pre-retirements needs (e.g., home expenses and college tuition), and time until investment maturity. Answers are processed to characterize the investor among several risk categories. Based on the answers (data provided) and the characterization of risk, the system determines from among certain managed portfolios which might be suitable for the investor. In addition, investors are given updated advice as their investments mature. In another embodiment of the invention, individuals can access Investments 101™ (a financial investment and planning service of the present invention) at anytime to answer basic investment questions.

In addition to the risk characterization provided to the investor, and guidance regarding portfolios associated therewith, investors can also access information providing a brief overview of each managed portfolio, including past performance, potential growth and a breakdown of funds including within the portfolio. The breakdown might include a graphic depiction of the portfolio's make-up (e.g., a pie-chart or a percentage listing of included funds).

Access to each of the managed portfolios available for investment is provided to the investor's computer terminal via the Internet, allowing the investor to invest into one or more chosen portfolios immediately. In one embodiment of the invention, the managed portfolios include no-load mutual funds; however, the managed portfolios of the present invention are not limited to any number or type of fund. The system periodically assesses (e.g., daily) each portfolio to assure that the funds included therein meet the investment objectives of the portfolio. As discussed, portfolio management is facilitated by Techfi.

The invention allows the investor to complete an application form and submit assets for investment into the managed portfolios. In one embodiment of the invention, the application is completed and submitted electronically via the Internet. In another embodiment of the invention, assets are accepted into investment funds by wire transfer, or by credit card, bankcard, bank account, brokerage account transfer, individual wire transfer or physical check received by the centralized custodian.

The purchase of securities is memorialized by certificates. All certificates are held, perhaps electronically, by the centralized custodian. As discussed, the centralized custodian could be Datalynx®. Employing a centralized custodian results in one entity providing back office and accounting services. The centralized custodian serves to lower the cost of managerial services for the investor as well as provide small financial institutions with an accounting of their investors' accounts.

A variety of means exist for accessing investor accounts. In one embodiment of the invention, the investor accesses their account via the Internet. Internet access may be through a turnkey device, which requires the investor to enter a password or account number at a log-in page. After accessing an individual account, the investor can view the amount in the account, invest in another portfolio, make further investments or shift assets from one portfolio to another. Investor access could similarly occur via direct dial modem, wireless transmission, or other means of electronic communication.

In another embodiment of the invention, the investor accesses their account through a financial institution. The financial institution might contract the services of the present invention for the benefit of its customers. The financial institution can provide access to individual portfolio accounts as well as well as provide additional assistance and information to its customers using the service.

In another embodiment of the invention, the investor accesses their account through a website bearing the logo of the financial institution through which the investor has accessed this system. Web pages are individually branded for each financial institution, allowing the financial institution to post marketing information concerning other services provided. In another embodiment of the invention, the services of the present invention might be transparent to the investor, the investor seeing only the identifying information of the financial institution.

In another embodiment of the invention, investors may access their account through an automatic teller machine (“ATM”). Access through an ATM provides the investor with the same capability as access via the Internet. Access through an ATM might also include a turnkey device. The investor might swipe a magnetic card at a bank machine, and enter a personal identification code to access their account. The services of the present invention might also be transparent to the investor in this embodiment of the invention, the investor seeing only the identifying information of the financial institution on ATM displays.

In all of the embodiments, above, the present invention also provides periodic account statements to investors. The statements (sent by traditional mailing or electronic transmission), might include identifying information of the financial institution (i.e., branded with a logo, trademark or marketing information of the financial institution). This feature also lends itself to the possible transparency of the present invention, if desired. The centralized custodian might also perform this task, alleviating administrative costs and logistical burdens for the financial institution offering the service.

In another embodiment of the invention, investors might be institutional entities, such as organizations offering pension plans for employees (e.g., a 401(k) delivery platform) In this embodiment, a third party administrative system might be employed for retirement plan administration.

In one embodiment of the invention, fees for the investment management services are based on total assets managed rather than on commission. Total assets managed could be quantified by individual investor account, and paid by the investor. The financial institutions could receive a portion of the fee as incentive to provide the product delivery system of the present invention to their customers. This fee structure minimizes the expense of investment management services, as it is not based on commission and the financial institution incurs no administrative costs. The system of the present invention uses Internet asset aggregation (large volume sales) and server to server database technology to ensure that management fees remain low. Automating account management, using an Internet delivery system and employing one centralized custodian also facilitates low management fees.

System Terms

Turnkey Device

The turnkey device allows a user access to an account electronically. The device requires an identifier or password unique to the user. With this identifier the user will have limited access to an individual account. The identifier could be, but is not limited to, a magnetic code contained on a bankcard in combination with a personal password or a password entered through a computer portal by way of a website interface. The turnkey device links the investor to one of the portfolio account pages (account portfolios), allowing the investor to view and/or change investment options. At the same time, investors can have basic investment questions answered before changing or adding to an investment option.

Risk Assessment Software

The system of the present invention might be software designed to assist investors in identifying their risk characteristics and provide guidance directed to certain portfolios consistent with their risk characteristics. A risk assessment questionnaire might be presented on the web page, leading to a brief assessment of the risk the investor is willing to incur. The questionnaire captures information regarding pre-retirement and retirement needs, along with years of investment until proposed retirement (i.e., maturity of the investment). Based on the information provided, the software determines one or more portfolios providing an appropriate amount of potential return versus risk, coordinating the portfolio selection to the investor's perceived characteristics of risk.

Investment Portfolio

An investment portfolio can comprise any funds and/or assets in which investors have placed money with an expected gain or security. The managed portfolios of the present invention are monitored by interval assessments of the mutual funds of which they are comprised. Most investment portfolios are comprised of several investment funds. These funds are most often, but are not limited to, no-load mutual funds.

The investor might view a listing of the investment portfolios provided, along with a sliding scale of the risk associated with each. Investors are provided with a suggestion of the portfolio with the appropriate risk and expected return if the investor uses the optional risk assessment software. However, investors can view the make-up of each portfolio as well as use the sliding scale for guidance to determine which portfolio is the most appropriate.

The investor might also view a graphic depiction of the funds included in any particular investment portfolio. Each portfolio includes investment funds targeted to certain types of performance. Each portfolio, therefore, has a calculated risk associated with it. The investor can access explanations of the risk, estimated potential growth and past performance for each portfolio.

Centralized Custodian

All securities are represented by a certificate, which may be either paper or electronic. Certificates identify the type and number of shares held (or purchased) by the investor in every fund included in every portfolio. The certificates are held by a Trust Bank. A centralized custodian might hold electronic certificates (i.e., records) of securities in a database. A centralized custodian refers to one custodian that holds all the certificates processed through the present invention. The one custodian reconciles purchases, redemptions and dividends of securities, along with periodic account statement reporting. Datalynx® is the centralized custodian in one embodiment of the present invention.

Portfolio Management System

Portfolio management system is used to interface with the centralized custodian. The portfolio management system retrieves price information and assesses the worth of the individual funds included in each portfolio. The portfolio management system facilitates the buying and selling of securities or mutual funds and continually assesses the funds included in each portfolio to determine and ensure that portfolio performance meets pre-determined objectives. The portfolio management system can also be used for accounting and daily analysis of the progress of a portfolio.

Private Label

Private label refers to the branding of web pages, display screens, marketing materials and account statements with logos, graphics, and trademarks of the financial institution coordinating the services of the present invention to the investor. The financial institution could be a bank, brokerage firm, credit union, investment advisor or an insurance company or agent.

What is claimed:

1. A method for providing investment management services, comprising the steps of:
a. allowing an investor to open an account through a financial institution;
b. providing a plurality of portfolios for investment through the financial institution, each portfolio having a different investment distribution representing a specific characteristic of risk;
c. accepting funds from the investor through the financial institution for placement into the account, the funds invested into one or more of the portfolios through purchase of securities;
d. processing and maintaining certificates, the certificates memorializing the securities purchased with the funds accepted from the investor for investment into one or more of the portfolios;
e. monitoring performance of the portfolios; and
f. allowing the investor to access the account through the financial institution to modify the funds invested into one or more of the portfolios through purchase or sale of securities.

2. The method of claim 1, further comprising the step of assessing investment risk characteristics of the investor.

3. The method of claim 2, wherein assessing the investment risk characteristics involves a financial questionnaire directed to identifying investment objectives.

4. The method of claim 3, wherein the financial questionnaire includes a six-step question prompt.

5. The method of claim 1, wherein the portfolios consist of no-load mutual funds.

6. The method of claim 1, wherein monitoring performance of the portfolios includes evaluating portfolio compliance with pre-determined risk objectives.

7. The method of claim 6, wherein monitoring performance of the portfolios occurs at least daily.

8. The method of claim 1, wherein monitoring performance of the portfolios employs Techfi portfolio management software.

9. The method of claim 1, wherein processing and maintaining certificates employs a centralized custodian.

10. The method of claim 9, wherein the centralized custodian is Datalynx®.

11. The method of claim 1, wherein the investment management services are transparent to the investor, the investor accessing the account by computer, over the Internet, through the financial institution, the web pages branded with identifying material of the financial institution.

12. The method of claim 1, wherein the investment management services are transparent to the investor, the investor accessing the account by automatic teller machine, through the financial institution, the displays of the automatic teller machine branded with identifying material of the financial institution.

13. The method of claim 1, further comprising the step of updating the account data and reporting the account status to the investor.

14. The method of claim 13, wherein updating the account data and reporting the account status to the investor is performed by the centralized custodian.

15. The method of claim 14, wherein the account status is mailed to the investor, the account status branded with identifying material of the financial institution.

15. The method of claim 1, wherein the financial institution is a bank.

16. The method of claim 1, wherein the financial institution is an investment agent, broker, advisor, or entity.

17. The method of claim 1, wherein the financial institution is an insurance agent, broker, or entity.

18. The method of claim 1, wherein fees for the investment management services are based on total assets managed rather than on commission.

19. The method of claim 18, wherein the total assets managed are total assets of an investor account, the fees being paid by the investor.

20. The method of claim 19, wherein a portion of the fee paid by the investor is provided to the financial institution as incentive for providing the investment management services.

21. A method for performing portfolio management services, comprising the steps of:
a. allowing an investor to open an account through a financial institution;
b. providing a plurality of portfolios for investor investment through the financial institution, each portfolio having a different investment distribution representing a specific characteristic of risk;
c. accepting funds from the investor through the financial institution for placement into the account, the funds invested into one or more of the portfolios through purchase of securities;
d. processing and maintaining certificates through a centralized custodian, the certificates memorializing the securities purchased with the funds accepted from the investor for investment into one or more of the portfolios;
e. monitoring performance of the portfolios through a portfolio manager;
f. allowing the investor to access the account through the financial institution to modify the funds invested into one or more of the portfolios through purchase or sale of securities; and
g. updating the account data and reporting the account status to the investor through the centralized custodian.

22. The method of claim 21, wherein the centralized custodian is Datalynx®.

23. The method of claim 21, wherein the portfolio manager is Techfi portfolio management software.

24. A method for performing portfolio management services, comprising the steps of:
a. allowing an investor to open an account;
b. providing a plurality of portfolios for investor investment, each portfolio having a different investment distribution representing a specific characteristic of risk;
c. accepting funds from the investor for placement into the account, the funds invested into one or more of the portfolios through purchase of securities;
d. processing and maintaining certificates through a centralized custodian, the certificates memorializing the securities purchased with the funds accepted from the investor for investment into one or more of the portfolios;
e. monitoring performance of the portfolios through a portfolio manager;
f. allowing the investor to access the account to modify the funds invested into one or more of the portfolios through purchase or sale of securities; and
g. updating the account data and reporting the account status to the investor through the centralized custodian.

25. The method of claim 24, wherein the centralized custodian is Datalynx®.

26. The method of claim 24, wherein the portfolio manager is Techfi portfolio management software.

27. The method of claim 24, further comprising the step of assessing investment risk characteristics of the investor.

28. The method of claim 24, wherein fees for the investment management services are based on a total amount of assets managed rather than on commission.

29. The method of claim 28, wherein the total assets managed are total assets of an investor account, the fees being paid by the investor.

30. The method of claim 29, wherein a portion of the fee paid by the investor is provided to the financial institution as incentive for providing the investment management services.

31. A method for managing investment portfolios, comprising the steps of:
a. assessing investment risk characteristics of an investor using a six-step financial questionnaire directed to identifying investment objectives;
b. allowing an investor to open an account through a financial institution;
c. providing a selection of six portfolios for investment through the financial institution, each portfolio consisting of a predetermined distribution of no-load mutual funds directed to a specific characteristic of risk;
d. accepting funds from the investor through the financial institution for placement into the account, the funds invested into one or more of the six portfolios through purchase of securities;
e. processing and maintaining certificates through a Datalynx® centralized custodian, the certificates memorializing the securities purchased with the funds accepted from the investor;
f. monitoring performance of the portfolios through Techfi portfolio management software;
g. allowing the investor to access the account through the financial institution to modify the funds invested into one or more of the six portfolios through purchase or sale of securities; and
h. updating the account data and reporting the account status to the investor through the Datalynx® centralized custodian, wherein fees charged for managing the investment portfolios is based on an aggregate of assets of the financial institution under management, wherein the managing the investment portfolios is transparent to the investor, all activities occurring through the financial institution are branded with identifying material of the financial institution.

32. A computer-readable medium that configures a computer system to perform a method for providing investment management services, the method comprising the steps of:
a. allowing an investor to open an account through a financial institution;
b. providing a plurality of portfolios for investment through the financial institution, each portfolio having a different investment distribution representing a specific characteristic of risk;
c. accepting funds from the investor through the financial institution for placement into the account, the funds invested into one or more of the portfolios through purchase of securities;
d. processing and maintaining certificates, the certificates memorializing the securities purchased with the funds accepted from the investor for investment into one or more of the portfolios;
e. monitoring performance of the portfolios; and
f. allowing the investor to access the account through the financial institution to modify the funds invested into one or more of the portfolios through purchase or sale of securities.

33. A computer-readable medium that configures a computer system to perform a method for performing portfolio management services, the method comprising the steps of:
a. allowing an investor to open an account through a financial institution;
b. providing a plurality of portfolios for investor investment through the financial institution, each portfolio having a different investment distribution representing a specific characteristic of risk;
c. accepting funds from the investor through the financial institution for placement into the account, the funds invested into one or more of the portfolios through purchase of securities;
d. processing and maintaining certificates through a centralized custodian, the certificates memorializing the securities purchased with the funds accepted from the investor for investment into one or more of the portfolios;
e. monitoring performance of the portfolios through a portfolio manager;
f. allowing the investor to access the account through the financial institution to modify the funds invested into one or more of the portfolios through purchase or sale of securities; and
g. updating the account data and reporting the account status to the investor through the centralized custodian.

34. A computer-readable medium that configures a computer system to perform a method for performing portfolio management services, the method comprising the steps of:
a. allowing an investor to open an account;
b. providing a plurality of portfolios for investor investment, each portfolio having a different investment distribution representing a specific characteristic of risk;
c. accepting funds from the investor for placement into the account, the funds invested into one or more of the portfolios through purchase of securities;
d. processing and maintaining certificates through a centralized custodian, the certificates memorializing the securities purchased with the funds accepted from the investor for investment into one or more of the portfolios;
e. monitoring performance of the portfolios through a portfolio manager;
f. allowing the investor to access the account to modify the funds invested into one or more of the portfolios through purchase or sale of securities; and
g. updating the account data and reporting the account status to the investor through the centralized custodian.

35. A computer-readable medium that configures a computer system to perform a method for managing investment portfolios, the method comprising the steps of:
a. assessing investment risk characteristics of an investor using a six-step financial questionnaire directed to identifying investment objectives;
b. allowing an investor to open an account through a financial institution;
c. providing a selection of six portfolios for investment through the financial institution, each portfolio consisting of a pre-determined distribution of no-load mutual funds directed to a specific characteristic of risk;
d. accepting funds from the investor through the financial institution for placement into the account, the funds invested into one or more of the six portfolios through purchase of securities;
e. processing and maintaining certificates through a Datalynx® centralized custodian, the certificates memorializing the securities purchased with the finds accepted from the investor;
f. monitoring performance of the portfolios through Techfi portfolio management software;
g. allowing the investor to access the account through the financial institution to modify the funds invested into one or more of the six portfolios through purchase or sale of securities; and
h. updating the account data and reporting the account status to the investor through the Datalynx® centralized custodian, wherein fees charged for managing the investment portfolios is based on an aggregate of assets of the financial institution under management, wherein the managing the investment portfolios is transparent to the investor, all activities occurring through the financial institution are branded with identifying material of the financial institution.

36. A computer-readable medium that stores a program for providing investment management services, the program comprising:
a. means for allowing an investor to open an account through a financial institution;
b. means for providing a plurality of portfolios for investment through the financial institution, each portfolio having a different investment distribution representing a specific characteristic of risk;
c. means for accepting funds from the investor through the financial institution for placement into the account, the funds invested into one or more of the portfolios through purchase of securities;
d. means for processing and maintaining certificates, the certificates memorializing the securities purchased with the funds accepted from the investor for investment into one or more of the portfolios;
e. means for monitoring performance of the portfolios; and
f. means for allowing the investor to access the account through the financial institution to modify the funds invested into one or more of the portfolios through purchase or sale of securities.

37. A computer-readable medium that stores a program for performing portfolio management services, the program comprising:
a. means for allowing an investor to open an account through a financial institution;
b. means for providing a plurality of portfolios for investor investment through the financial institution, each portfolio having a different investment distribution representing a specific characteristic of risk;
c. means for accepting funds from the investor through the financial institution for placement into the account, the funds invested into one or more of the portfolios through purchase of securities;
d. means for processing and maintaining certificates through a centralized custodian, the certificates memorializing the securities purchased with the funds accepted from the investor for investment into one or more of the portfolios;
e. means for monitoring performance of the portfolios through a portfolio manager;
f. means for allowing the investor to access the account through the financial institution to modify the funds invested into one or more of the portfolios through purchase or sale of securities; and
g. means for updating the account data and reporting the account status to the investor through the centralized custodian.

38. A computer-readable medium that stores a program for performing portfolio management services, the program comprising:
a. means for allowing an investor to open an account;
b. means for providing a plurality of portfolios for investor investment, each portfolio having a different investment distribution representing a specific characteristic of risk;
c. means for accepting finds from the investor for placement into the account, the funds invested into one or more of the portfolios through purchase of securities;
d. means for processing and maintaining certificates through a centralized custodian, the certificates memorializing the securities purchased with the funds accepted from the investor for investment into one or more of the portfolios;
e. means for monitoring performance of the portfolios through a portfolio manager;
f. means for allowing the investor to access the account to modify the funds invested into one or more of the portfolios through purchase or sale of securities; and
g. means for updating the account data and reporting the account status to the investor through the centralized custodian.

39. A computer-readable medium that stores a program for managing investment portfolios, the program comprising:
a. means for assessing investment risk characteristics of an investor using a six-step financial questionnaire directed to identifying investment objectives;
b. means for allowing an investor to open an account through a financial institution;
c. means for providing a selection of six portfolios for investment through the financial institution, each portfolio consisting of a predetermined distribution of no-load mutual funds directed to a specific characteristic of risk;
d. means for accepting funds from the investor through the financial institution for placement into the account, the funds invested into one or more of the six portfolios through purchase of securities;
e. means for processing and maintaining certificates through a Datalynx® centralized custodian, the certificates memorializing the securities purchased with the funds accepted from the investor;
f. means for monitoring performance of the portfolios through Techfi portfolio management software;
g. means for allowing the investor to access the account through the financial institution to modify the funds invested into one or more of the six portfolios through purchase or sale of securities; and
h. means for updating the account data and reporting the account status to the investor through the Datalynx® centralized custodian, wherein fees charged for managing the investment portfolios is based on an aggregate of assets of the financial institution under management, wherein the managing the investment portfolios is transparent to the investor, all activities occurring through the financial institution are branded with identifying material of the financial institution.
